(19) United States
(12) Patent Application Publication
(10) Pub. No.: US 2007/0105083 A1
(43) Pub. Date: May 10, 2007

(54) Rigid birth simulator having an interactive optical display

(76) Inventors: Robert Riener, Wangen (CH); Rainer Burgkart, Munchen (DE)

Correspondence Address: HENRY M FEIEREISEN, LLC, 350 FIFTH AVENUE, SUITE 4714, NEW YORK, NY, 10118, US

(21) Appl. No.: 10/563,003

(22) PCT Filed: Jun. 24, 2004
(86) PCT No.: PCT/DE04/01332

§ 371 Date: Sep. 29, 2006

(30) Foreign Application Priority Data
Jun. 24, 2003 (DE) 103 28 354.4

(51) Int. Cl. G09B 23/28

(52) U.S. Cl. 434/273; 434/262

(57) ABSTRACT

The invention relates to a birth simulator having an interactive optical display for displaying prenatal handling methods and for simulating selected situations during birth. The birth simulator has the following features: A womb torso (1), which is joined to a base (3), a child model (2), which is placed inside the womb torso (1); a force/moment sensor arrangement (6), which connects the child model (2) to the base (3) in a fixed manner, whereby said force/moment sensor arrangement (6) is configured for detecting forces and moments, which an examining individual (5) exerts via hands or medical instruments onto the child model (2), and for providing the result of this detection in the form of measurement signals; a display screen and a programmable evaluation device, which has a computer and which is connected to the force/moment sensor arrangement (6) and to the display screen in a manner that enables the transmission of signals, whereby a simulation program implemented inside the computer is configured so that the measurement signals are transformed into image signals of the type that depict, in real time, the natural movement behavior of a child in the womb as adequate reaction movements of the action of the exerted forces and moments.

The present invention relates to a birth simulator for displaying prenatal handling methods and for simulating selected situations during birth.

Training of midwives and gynecologists is very costly, as it can be hardly carried out with pregnant women themselves. Especially, when complex emergency situations occur, it is not possible or justifiable, for ethical reasons, to include inexperienced individuals into the midwifery actively. In some cases, difficult problems occur unexpectedly during birth. In such cases, midwives and gynecologists have to be present during birth for a long time without being able to help. Active training of such individuals can be started only, as passive training has been advanced very extensively. All actions to be done by them must be supervised by experienced medical experts in order to hold the remaining risk for mother and child as low as possible.

Gynecological training is assisted by using body models, films and computer animations. Models made of thermosetting resins and formed in segments to be joined together are available, which enable anatomical, physiological or pathological relations to be understood three-dimensionally. Also, soft-elastic models are known, which are intended to imitate human tactile properties as good as possible, i.e. a formable child-like puppet is placed in an womb torso anatomically formed with high precision.

Thus, midwives and gynecologist to be trained can touch such models and exercise definite basic manipulations and to sink into the mind the three-dimensional relations such as presentations of fetus, for example. Devices used for such and similar purposes are described in WO 02/01536 A1 and U.S. Pat. No. 5,509,810.

As the body models, films or computer animations according to the prior art are insufficiently suited for carrying out a training close to reality, object of this invention is to provide a device for simulating any birth, which enables obstetric manipulations to be learned or trained more effectively than corresponding means according to prior art are capable to do.

This object is solved by a rigid birth simulator having an interactive optical display according to claim 1, wherein the birth simulator comprises the following features: a womb torso, which is joined to a base, and a child model, which is placed inside the womb torso, wherein preferably, natural proportions, i.e. human shapes and sizes are complied with and haptics is realized. The child model is connected to the base in a fixed manner via a force/moment sensor arrangement. The force/moment sensor arrangement is configured so that forces and moments, which an examining individual exerts onto the child model by the hands or by using medical instruments, are detected and provided as measurement signals. Forces and moments can be exerted onto the child model directly or through the flexible abdominal wall of the womb torso indirectly. Furthermore, a screen (optical display) and a programmable evaluation device, which has a computer and is connected to the force/moment sensor arrangement and to the display as well via a signal path, are provided. A simulation program with force and movement feedback included is implemented inside the computer, i.e. stored in it. This simulation program is configured so that the measurement signals are transformed into image signals of the type that depict, in real time, the natural movement behavior of a child in the womb as adequate reaction movements of the action of the forces and moments exerted. Thus, images are displayed on the screen, which show, how a natural child would behave in its mother's womb, if the forces and moments exerted onto mother and child were the same as those exerted onto the birth simulator according to the invention, i.e. by pressing the womb torso or by seizing the head of the child model by delivery forceps and pulling it.

This invention is especially advantageous in that it offers possibilities to simulate various medical situations, which can occur prior to and during birth, by using a model of a human body and visualizing them graphically. The child model can be seized by the hands only, but also by an instrument such as delivery forceps or a vacuum extractor, for example, in order to exercise the correct use of them. The movement of child and the effects on the physiology of mother and child, which are caused by the forces exerted by the operator, are visualized on the display immediately and interactively. Also, it is very important that various medical situations can be selected by changing the stored program, i.e. by simply “pushing a button”.

It should be mentioned that the child model is mechanically fixed and its movements are represented visually on the display, only. As the birth simulator has a simple mechanical structure and is very sturdy, it is didactically pretentious and low in cost.

According to claim 2, the child model is detachably connected to the force/moment sensor arrangement, and the womb torso comprises a flap. Thus, it is possible to use different child models and to exchange them easily.

According to claim 3, the child model can be connected to the force/moment sensor arrangement in different presentations. This enables special presentations of a child to be simulated.

According to claim 4, one sound generator at least is connected to the evaluation device via a signal path so that typical sounds, which are uttered by mother or child or caused by medical instruments during a real examination or a natural birth, can be replayed. The sounds can be generated synthetically or can be of natural origin; i.e. sounds recorded onto a tape during an adequate natural birth. By this measure, an almost real impression is given to all of the individuals to be trained, when mans, for example, which are uttered by the pregnant woman because of vehement labor pains during birth, are replayed, at the same time.

According to claim 5, the sound generator is arranged inside the womb torso and/or the child model so that sounds occurring inside the womb torso can be heard almost truly. Especially, sounds given by the child can be simulated very really.

According to claim 6, a signal and reference program is implemented in the computer, which causes operation instructions, simulated physiological values, device outputs and alarms, e.g. dangerous situations, time behaviors of the physiological sizes of mother and child calculated or also operation instructions to be shown on the display. An expert in this field certainly knows in which way this program and the simulation program can work together.

According to claim 7, a child model used for the birth simulator according to claims 1 to 6 is claimed as an independent invention.

Force and/or pressure sensors are attached to the child model, which is composed of formable segments, in the neck area and/or skullcap area thereof, and are connected to the evaluation device via a signal path. The child model equipped with such sensors enables additional and more precise information on force exerted onto it and palpation proceedings to be gained in order to provide better information on forces and/or moments, which are necessary for calculating reaction forces and reaction movements accompanying them.

Furthermore, it should be mentioned that an expert will attach another sensors to the child model or the womb torso at suitable parts thereof, if necessary, in order to gain signals required when a concrete movement simulation is to be realized. For example, such additional sensors are pressure sensors attached to the womb torso at the abdominal area thereof. The measurement signals of such additional sensors are supplied to the simulation program and/or the signal and reference program.

Force/moment behaviors can also be recorded, when a trained individual is simulating a birth by using the birth simulator. The same is true for an individual to be trained. Thereafter, the force behaviors gained with the two simulation processes are compared with each other. This method is didactically very valuable.

This invention is preferably suited for human applications. In principle, this invention can also be used in the veterinary medicine.

Below, embodiments of this invention will be described in detail in connection with the accompanying drawings.

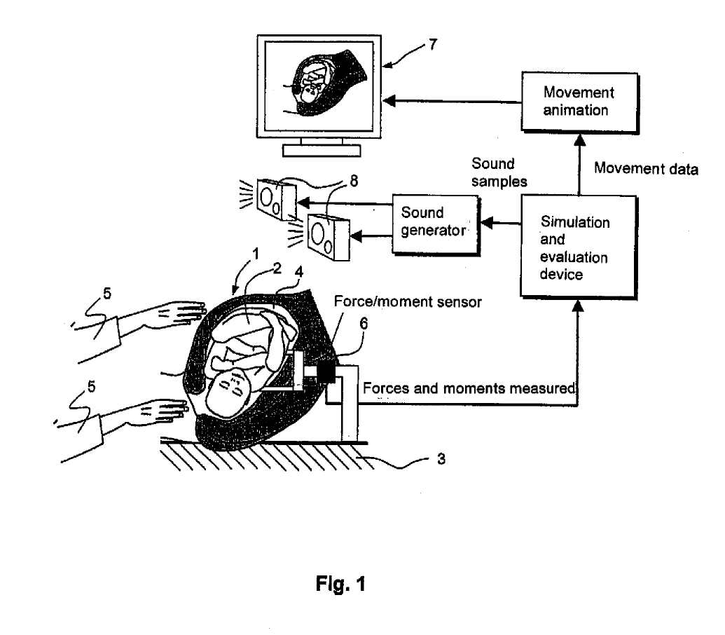

FIG. 1 shows schematically this invention with the components thereof.

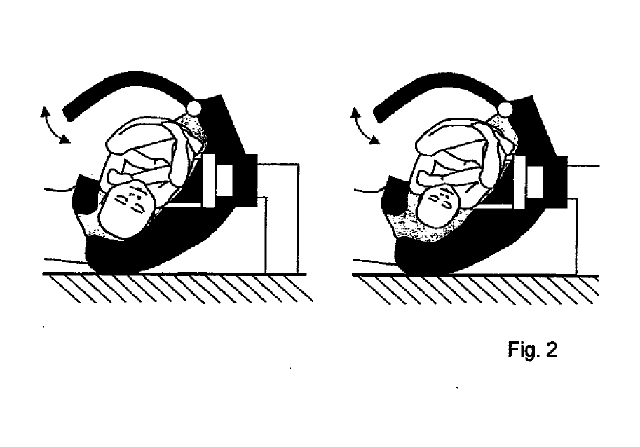

FIG. 2 shows two womb torsos opened.

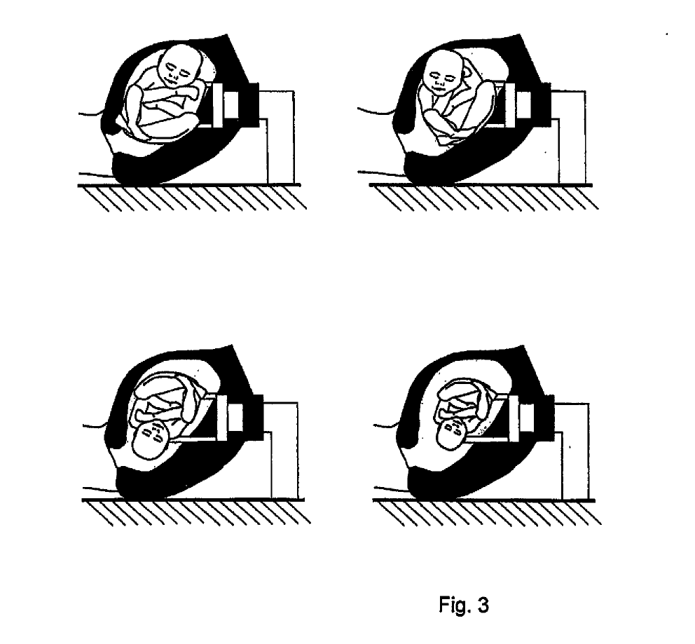

FIG. 3 shows four womb torsos with different child models inserted.

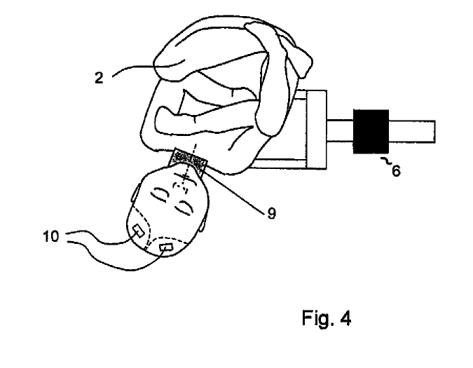

FIG. 4 shows a child model provided with sensors.

FIG. 1 shows schematically the cross-section of a birth simulator in shape of a womb torso 1 of a pregnant woman with a child model 2 inserted. The womb torso 1 is fixed on a base 3 such as a table, for example. The child model 2 is placed in a cavity 4 which simulates the uterus. The womb torso 1 and the child model 2 are made of soft-elastic resin. The child model 2 is connected to the base 3 via a force/moment six components detection sensor 6.

An individual 5 to be trained can touch the child model in the same way as a child is touched during a natural birth. The forces and moments exerted by the touch are detected by the force/moment six components detection sensor 6, transformed into signals and transmitted to the simulation and evaluation device. The measurement data can be stored. This enables the measurement data to be compared with data, which is gained from forces exerted by an experienced obstetrician and stored as reference input values in the computer. Based on the differences between the actual force behaviors and the stored reference input value, conclusions on the training success gained by the individual to be trained can be drawn.

When the individual 5 touches the child model by the hands indirectly through the abdominal wall of womb torso 1 or directly by the hands or by means of an medical instrument, measurement signals are generated by the force/moment six components detection sensor, which are used to calculate the movements theoretically resulting from the touch. The child arithmetically simulated in the simulation and evaluation device carries out a movement which corresponds to the real reaction movement of a natural child.

Thus, a computer model is included in the simulation program for calculating the birth simulation, which expresses the bio-mechanical relations between pelvis, uterus, ligaments, sinews, skin and muscles of the mother and the body of the child model. This computer model describes the static and dynamic relations between forces and moments, which an individual such as a midwife to be trained exerts onto the child model, and the presentations and movements of the child relative to the body of mother. Thus, movements of the child model 2 can be calculated based on the measured forces and moments.

Furthermore, based on the movement information processed in the simulation program, movements and deformations of anatomical components such as pelvis, uterus, ligaments, sinews, skin and muscles of mother and child are determined by a movement animation calculation and visualized in real time on a monitor 7. Different kinds of representation can be selected, for example, in form of X-ray images or ultrasonic images, wherein there is the possibility to emphasize especially dangerous areas or injuries by colors. It is also possible to switch between different kinds of representation. As the visual information and the haptic information are transmitted at the same time, the operating individual 5 receives a visual overall impression very realistically.

In addition, threshold values of pains can be determined from bio-mechanical calculations of knuckles, which, when being exceeded, cause a sound sample to be replayed. Sound samples are stored in a memory and are replayed via a stereophonic loudspeaker system 8, if demanded. When, for example, a cry of pain is triggered by a wrong manipulation, the heartbeat of child or mother are audible or the child model cries like a natural child just born successfully, this will have a long lasting physiologic effect on the operating individual 5.

Such a visually graphical representation of the resultant movement of child will impart to the operating individual a subjective impression of a real reaction.

By selecting proper parameters for the birth simulation calculation, it is possible to simulate normal birth procedures or movements of a child, but also to represent and impart clearly rare situations and problematic cases.

FIG. 2 shows two womb torsos having a flap which can be rotated at a joint in the directions indicated by an arrow. As shown in this figure, a bigger child was exchanged for a smaller one.

FIG. 3 shows four womb torsos, in which child models of different sizes an in different presentations are placed.

FIG. 4 shows a child model 2, the head of which is joined with the torso through a force/moment sensor 9. When simulating a birth, it is very important to exercise manipulations with the head of the child model 2. During such a manipulation, the neck of child is especially stressed. Additional force sensors 10 are arranged on the skullcap of the child model, which enable spatially selected force actions to be detected clearly in this area during palpation, for example. When a birth is simulated, it is especially important to monitor the manipulations done with the head, which can be realized precisely with this embodiment of the child model. Transmission of electric measurement signals to the evaluation device can be performed through a signal line or in a wireless manner.

Below, additional information for realizing the bio-mechanic model is given.

The invention realized based on this bio-mechanical model.

In this bio-mechanic model, the relation between the loads (manipulation), i.e. forces and moments exerted onto the child (causes), and the movement and presentation of the child (effect) is represented.

An expert in this field certainly knows, that the bio-mechanic model must not include all of the anatomic components and shapes in detail. It is sufficient to explain the mathematical relations between the forces exerted and the resultant movements “abstractly”, to a certain extent. That is, a mathematical function describes, which presentation, orientation and speed is gained, when a force and a moment is exerted onto the child at a definite part thereof in a certain direction, wherein the forces and moments can act in three dimensions (three-dimensional direction) and work onto the child at a random part thereof. Of course, presentations, orientations and speeds resulting from the forces and moments have also to be given three-dimensionally. Moreover, the relation between force/moment and presentation/movement is dependent on the actual presentation of child inside the uterus and the birth channel. These mathematical relations can simply be described based on linear or non-linear algebraic equations. Then, a parametric representation has to be carried out. The choice of parameters determines how the normal or pathologic course of birth can be simulated very close to reality. The parameters can be estimated theoretically or gained by experiments/measurements.

Below, information for realizing the graphic displays is given.

Internal anatomic components such as pelvic bones, uterus, placenta, uterine orifice and blood-vessels and the child as well are visualized on the display. Optionally, the monitor can be used in the stereo modus in connection with a so-called “Schutterbrille”, but there is also the possibility to use a stereo data helmet. The movement animation proceeds in synchronization with the forces exerted onto the womb torso or the child model. Visualization on the monitor is based on CT, MRT and ultrasonic photos segmented and three-dimensionally reconstructed. The reconstructed anatomic representation serves as additional information having a highly didactic ranking for medical education. It is not possible to make such a reconstructed anatomic representation available with a real birth. In clinic routines, ultrasonic techniques at the very most are used for monitoring and evaluating a birth. Such ultrasonic photos can be simulated with the movement simulation based on composite single photos running synchronously with the birth.

For a graphic animation, changes of presentation of body segments in synchronization with movements, changes in the course of blood-vessels or the umbilical cord and deformations of muscles, uterus, placenta and the like are considered. An expert in this field knows how movement procedures are visualized by using so-called “kinematic CT and MRT pictures”. However, this is moving-picture technology only, which does not allow any interactive operation to be performed with more than one degree of freedom and, therefore, can be used in the VR range (range of virtual reality) to a limited extent, only. An alternative animation is based on models. With this animation, all of the components are modeled based on the relevant geometric and viscoelastic properties and the mechanic co-operation thereof. Finite element calculations and complex multi-body contact models are required to realize a simulation close to reality, which, however, can increase the technical expenditure and endanger the real-time capability.

Therefore, a combined procedure is recommended, where image data and anatomic model considerations are used. With this procedure, geometric data reconstructed from many discrete birth moments have to be interpolated and extrapolated so that any random presentation of child can be represented in every relevant degree of freedom. Interpolation and extrapolation can be assisted by models, with a constant volume and length of certain body parts being considered, for example. As this requires a relatively low calculation extent only, real-time and smooth movements in any direction can be gained.

Training success is enhanced in that the physiologic parameters of mother and child (e.g. birth pangs and blood pressure of the mother and pulse of the child) calculated during the simulation are displayed as time courses.

Below, information for realizing the acoustic means is given.

During birth, some different acoustic signals are generated by loudspeakers. Pain cries of mother and sounds, which occur when the child comes out, are among them. Furthermore, birth pangs of mother and the electrocardiogram of the child, for example, are represented as acoustic signals. Loudspeakers can be arranged close to the artificial body or inserted into it so that they are not visible from the outside.

Birth sounds can be recorded with several test persons.

Models are used to relate the kind of a sound to a corresponding situation and the actions done by the operator. At first, based on experiences gained by numerous gynecologists, relations between such actions and the sounds can be described qualitatively by using linguistic variables. Then, quantitative relations can be derived from such linguistic data by using the Fuzzy-logic method.

1.-7. (canceled)

8. A birth simulator, comprising:
a base;
a womb torso joined to the base, said womb torso having an flexible abdominal wall;
a child model placed inside the womb torso;
a sensor arrangement connecting the child model to the base to measure at least one of a force and a torque applied by an examining individual either directly to the child model manually or by using medical instruments, or indirectly via the flexible abdominal wall;
a programmable evaluation device receiving a measurement signal from the sensor arrangement and transforming the measurement signal into an image signal; and
a display which renders the image signal as a simulation of a natural movement which a natural child would exhibit in the womb of a mother in response to the exerted force or torque during a medical examination or during natural child birth.

9. The birth simulator of claim 8, wherein the image signal is rendered in real time, in a slow motion or in a time compression mode.

10. The birth simulator of claim 8, wherein the child model and the womb torso are constructed so as to match a shape and size of a natural body.

11. The birth simulator of claim 8, further comprising a haptic feedback to the examining individual.

12. The birth simulator of claim 8, wherein the child model is detachably connected to the sensor arrangement.

13. The birth simulator of claim 8, wherein the womb torso includes a swingable flap for opening and closing.

14. The birth simulator of claim 12, wherein the child model is adapted for connection to the sensor arrangement in different positions.

15. The birth simulator of claim 8, further comprising a sound generator connected to the evaluation device for generating sounds based on the measurement signal, wherein the generated sounds resemble sounds produced by the mother or child or by medical instruments during natural child birth.

16. The birth simulator of claim 15, wherein the sound generator is arranged inside the womb torso or the child model, or both.

17. The birth simulator of claim 8, wherein the evaluation device produces output signals for rendering on the display operating instructions, simulated physiologic values, device outputs and alarms.

18. The birth simulator of claim 8, wherein the sensor arrangement includes a force and/or pressure sensor made of deformable segments and arranged in the neck region or skullcap region of the child model.

19. A child model for use with the birth simulator of claim 1, wherein the sensor arrangement comprises a force and/or pressure sensor made of deformable segments and arranged in the neck region or skullcap region of the child model.
